(19) United States
(12) Patent Application Publication
(10) Pub. No.: US 2021/0381294 A1
(43) Pub. Date: Dec. 9, 2021

(54) Device for a system for opening / closing a door or sliding shutter

(71) Applicant: IN & TEC S.R.L., Brescia (BS) (IT)

(72) Inventor: Luciano Bacchetti, Nave (BS) (IT)

(21) Appl. No.: 16/962,818

(22) PCT Filed: Feb. 4, 2019
(86) PCT No.: PCT/IB2019/050865

§ 371 Date: Jul. 16, 2020

(30) Foreign Application Priority Data
Feb. 2, 2018 (IT) 102018000002338
Feb. 2, 2018 (IT) 102018000002339
Feb. 2, 2018 (IT) 102018000002341
Feb. 2, 2018 (IT) 102018000002343

(51) Int. Cl. E05F 15/56

(52) U.S. Cl. CPC E05F 15/56; E05Y 2900/132; E05Y 2201/474; E05Y 2201/454

(57) ABSTRACT

A device for a system for opening/closing a door or a sliding shutter includes a jacket defining a longitudinal axis and a rod, having a cylinder at one end inserted into the jacket and an opposite end external thereto, which reciprocally slides along the longitudinal axis or along an axis parallel thereto in relation to the jacket between a position proximal to the jacket and a position distal therefrom.

### FIELD OF THE INVENTION

The present invention generally relates to the technical field of moving systems, and it particularly relates to a device for a system for opening/closing a door or sliding shutter, in particular a linear actuator or damping cylinder.

Furthermore, the invention relates to a system for opening/closing a door or sliding shutter including such device.

### BACKGROUND OF THE INVENTION

It is known that two main types of linear actuators exist, that is to say hydraulic or pneumatic.

In both cases, the actuator must be connected with a connecting line of a working fluid, whether oil or compressed air.

This entails the certain disadvantage of having a working fluid to handle, with all the related problems. As a consequence, such types of actuators are unsuitable for a whole series of non-industrial applications, such as the movement of a door or a sliding shutter.

Furthermore, compression gas springs and traction gas springs are well known. In such types of springs, a gas, generally nitrogen or compressed air, is used in order to bring the rod back to the rest position once the rod itself is pushed or pulled into a working position.

A known disadvantage of such types of springs is that they tend to discharge over time, causing their regular replacement. Moreover, if used in a closing system of a door or a sliding shutter they violently close the latter, risking to damage it or even break it.

An additional disadvantage lies in the fact that in the gas springs the closing force increases with the compression of the same gas and, consequently, with the length of the shutter to close. In the case of short shutters, such as refrigerated counter doors or similar, the gas spring provides a relatively low force, therefore, in order to obtain an adequate force, the system must be enlarged, by increasing its overall dimensions.

### SUMMARY OF THE INVENTION

Object of the present invention is to overcome, at least partially, the drawbacks illustrated above, by providing a device having high functionality characteristics, simple constructive features and low cost.

Another object of the invention is to provide a device, more particularly a linear actuator of low-bulkiness, which allows to close shutters of limited length, such as refrigerated counters or showcase shutters.

Another object of the invention is to provide a device, more particularly a linear actuator, with a controlled movement.

Another object of the invention is to provide a device, more particularly a linear actuator requiring as little maintenance as possible.

Another object of the invention is to provide a device, more particularly a linear actuator, which ensures the automatic closing/opening of a door or a shutter from the open/closed position.

Another object of the invention is to provide a device, more particularly a linear actuator, with a minimum number of components.

Another object of the invention is to provide a device, more particularly a damping cylinder, with a controlled movement.

Another object of the invention is to provide a device, more particularly a damping cylinder, requiring as little maintenance as possible.

Another object of the invention is to provide a device, more particularly a damping cylinder, with a minimum number of components.

Such objects, as well as others that will be clearer hereinafter, are fulfilled by a device, more particularly a linear actuator and/or a damping cylinder, according to what is herein described, shown and/or claimed.

The dependent claims define advantageous embodiments of the invention.

### BRIEF DESCRIPTION OF THE DRAWINGS

Further features and advantages of the present invention will become more evident by reading the detailed description of some preferred but not exclusive embodiments of the invention, illustrated as a non-limiting example, with the help of the annexed drawings wherein:

FIGS. 1A and 1B are schematic views of an embodiment of the system 100 for closing an opening P by a sliding shutter D moved by a preferred but not exclusive embodiment of a linear actuator 1, respectively in the closed position of the shutter D and in the open position of the shutter D;

FIGS. 2A and 2B are schematic views of the embodiment of the system 100 of FIGS. 1A and 1A respectively in the closed and in the open position of the shutter D;

FIG. 3 is an exploded view of a first embodiment of the linear actuator 1;

FIGS. 4A and 4B are section views of the embodiment of the linear actuator 1 shown in FIG. 3, respectively in the closed and in the open position of the shutter D;

FIG. 5 is an exploded view of a second embodiment of the linear actuator 1;

FIGS. 6A and 6B are section views of the embodiment of the linear actuator 1 shown in FIG. 5, respectively in the closed and in the open position of the shutter D;

FIGS. 7A and 7B are section views of an embodiment of a hydraulic damping cylinder 200 respectively in the closed and in the open position of the shutter D.

### DETAILED DESCRIPTION OF SOME PREFERRED EMBODIMENTS

With reference to the above mentioned figures, it is here described a linear actuator 1, suitable for linearly move any object, mechanism or system. The linear actuator may directly or indirectly act, through pulleys or sprockets.

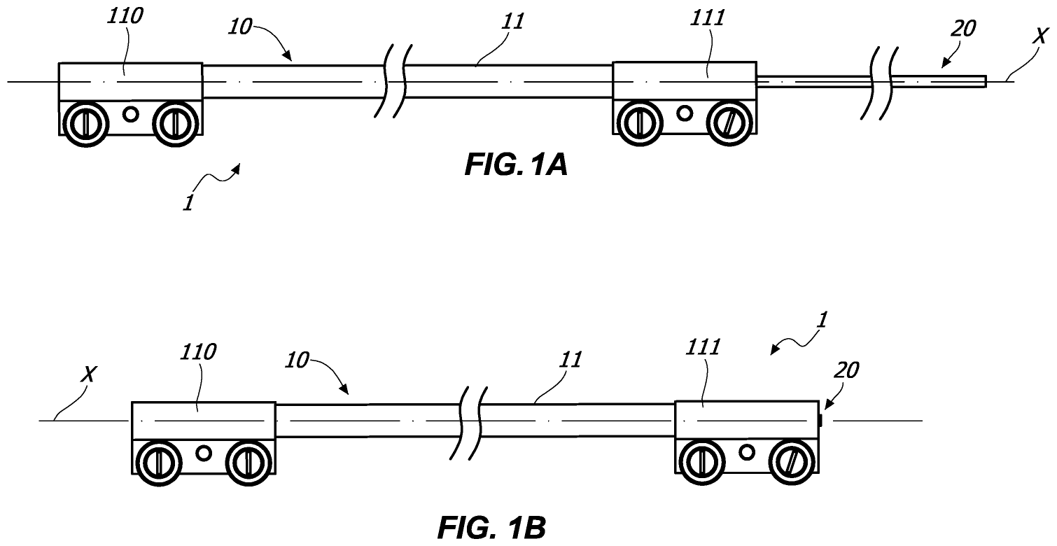

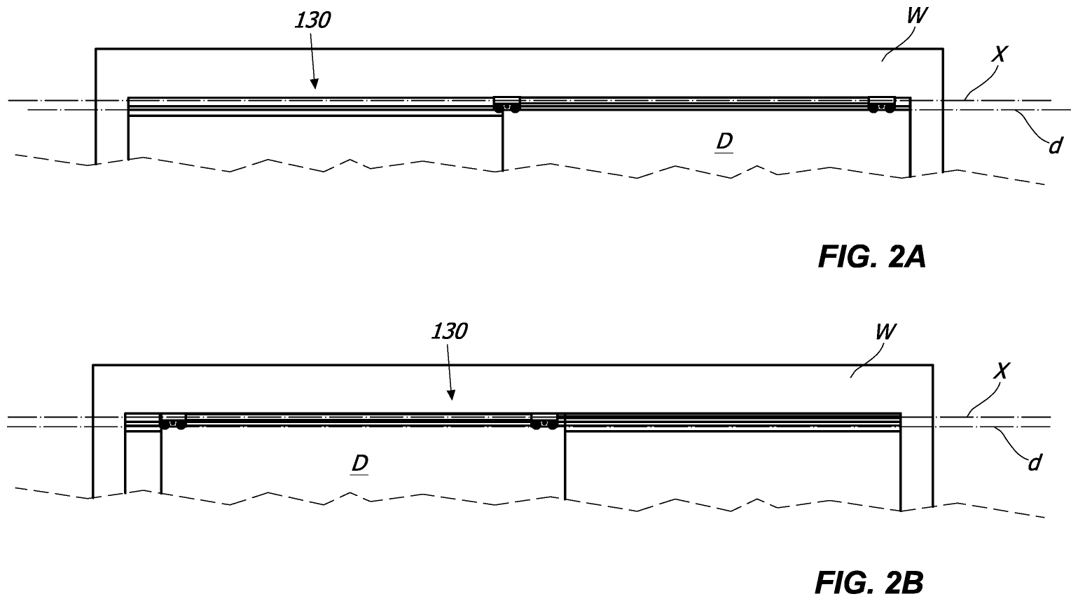

In a preferred but not exclusive embodiment of the invention, for example shown in FIGS. 1A to 2B, the linear actuator 1 may be used in a system 100 for closing/opening an opening P by a closing element D movable between an open position and a closed position.

In general, the opening P may be any opening made in any stationary supporting structure, and the closing element D may be any, such as a door, a shutter, a hatch, a trap door or similar. Similarly, the closing element D may move with any motion, which can be linear along a sliding plane or rotational around a rotation axis.

In the latter case, the linear actuator 1 may act as door closer or as hinge device, or it may be an integral part of it.

For example, as shown in FIGS. 1A and 1B, the opening P may be a passage made in the frame W of a refrigerator, and the closing element D may be a shutter, such as a glass shutter, sliding on a plane defined by the same shutter between a closed position, shown in FIG. 1A, and an open position, shown in FIG. 1B.

In general, the linear actuator 1 may comprise a jacket 10 defining an axis X and a rod 20 sliding therein between a retracted position, as shown in FIG. 1B, and an extended position, shown for example in FIG. 1A.

It is understood that even though, hereinafter, the jacket 10 is described as a movable element in respect to the stationary rod 20, the opposite situation may occur, i.e. the rod being movable in respect to the stationary jacket, without thereby departing from the scope of protection of the appended claims.

It is also understood that even though in the above illustrated embodiments a single rod 20 and a single jacket 10 have been provided, the linear actuator 1 may comprise a plurality of jackets and/or a plurality of rods, as well as it may be coupled with other linear actuators, like for example gas springs of a per se known type, without thereby departing from the scope of protection of the appended claims.

Anyway, the movable element of the linear actuator 1, the jacket 10 in the example of the embodiment illustrated in the attached drawings, may be reciprocally connected with a sliding shutter D, while the stationary element, the rod 20 in the example of the embodiment illustrated in the attached drawings, may be fixed to the frame W.

Therefore, the jacket 10 may jointly slide with the shutter between the opening and closing positions thereof.

For this purpose, sliders may be provided, such as two or more sliders 110, 111, operatively involved in one or more guideways 120 defining a sliding direction d substantially parallel to the axis X defined by the jacket.

Advantageously, the sliders 110, 111 may be couplable to the tubular element 11 of the linear actuator 10, for example slidably inserted thereon.

In this manner, a compact linear actuator is obtained, which may be functional and simple to produce.

Such characteristics allow its concealed insertion in an elongated hollow tubular or “C”-shaped profile 130 inferiorly open, which may be inserted in the frame W or it may be an integral part thereof.

Preferably, the profile 130 with the linear actuator 1 may be placed above the shutter D. On the other hand, it may be also placed on the side of the shutter D or below it, using appropriate return means such as pulleys and ropes.

The linear actuator 1 usable in the system 100 may be of any type. For example, it may be a gas spring of a per se known type.

Preferably, however, the actuator 1 may present the characteristics described hereinafter.

It is understood that, even though hereinafter a linear actuator 1 is described for moving the sliding shutter D, the linear actuator 1 may have any use, without thereby departing from the scope of protection of the appended claims.

As mentioned above, in the present description the concept of sliding between the rod 20 and the jacket 10 and the relative parts is to be understood in a relative and not absolute manner. Therefore, even where for simplicity the sliding of the rod 20 will be mentioned with respect to the jacket 10, it is understood that the sliding between these parts is reciprocal and relative to each other.

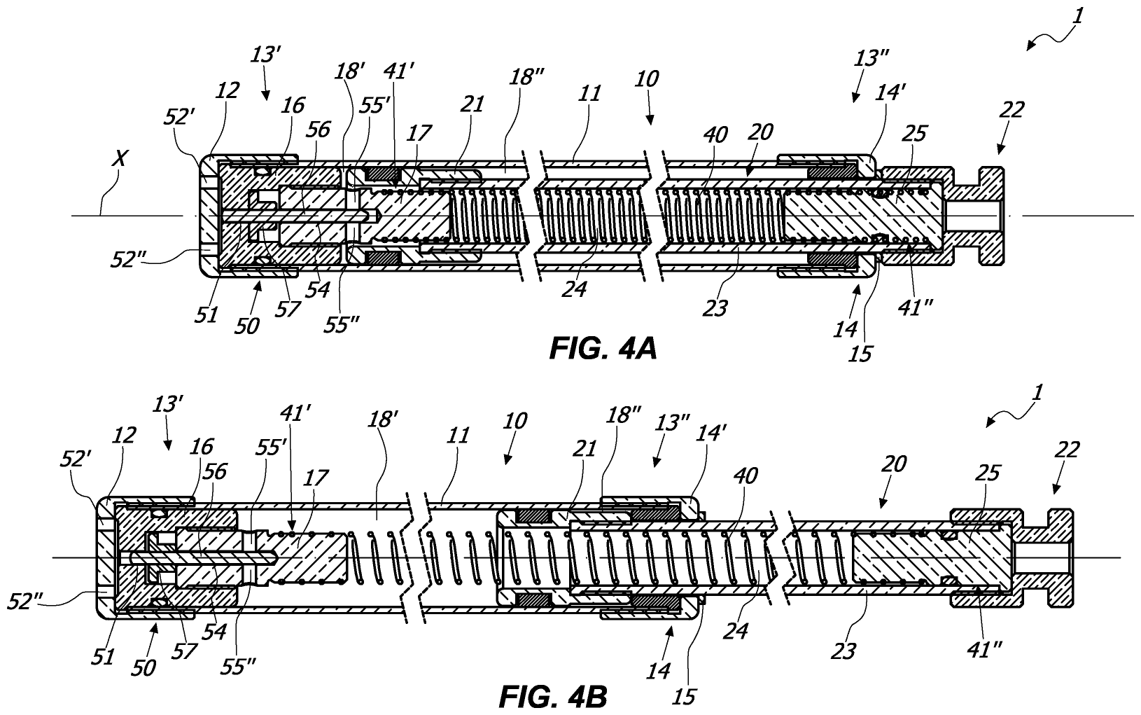

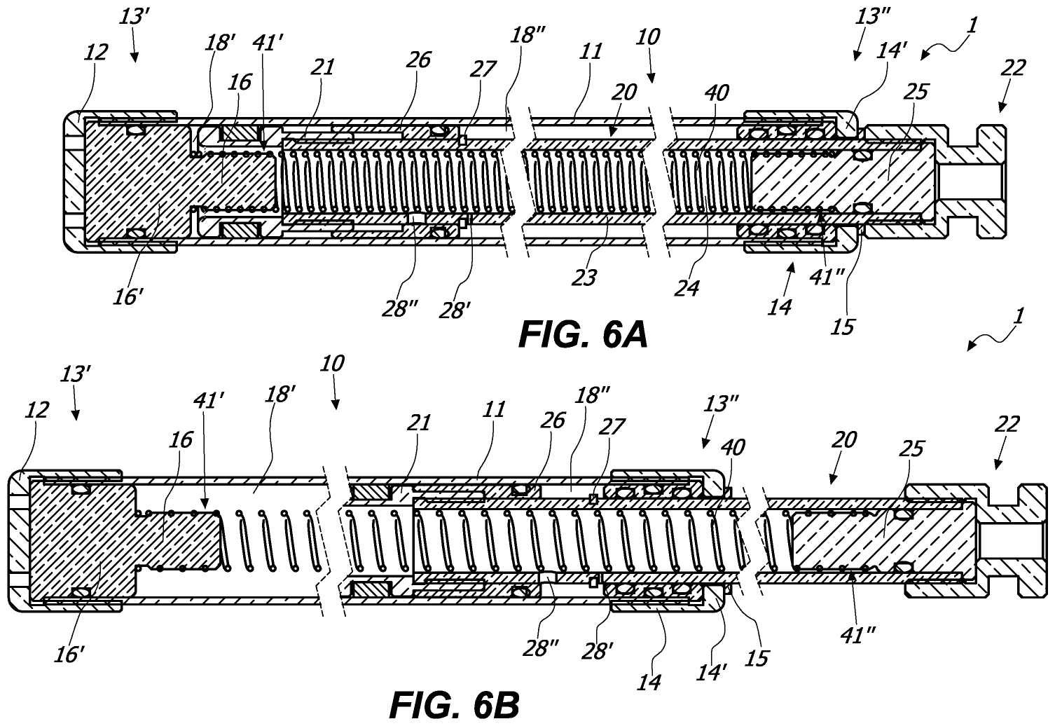

In the embodiments shown in FIGS. 4A and 6A the linear actuator 1 is in its rest position, that is to say the position wherein the same linear actuator 1 remains if not subjected to external forces. Such rest position may possibly, even though not necessarily, correspond to the closed position D of the shutter.

On the other hand, in the embodiments illustrated in FIGS. 4B and 6B the linear actuator 1 is in its working position, that is to say the one where the user acting on the shutter D brings the same linear actuator 1 starting from the rest position. Such working position may possibly, but not necessarily, correspond to the totally or partially open position of the shutter D. From such working position the linear actuator 1 may automatically close the shutter D, or, equally, the linear actuator 1 may automatically return in the rest position.

Therefore, in such embodiments, the linear actuator 1 works in traction.

Advantageously, the rod 20 may comprise an end cylinder 21 within the jacket 10 and an opposite end 22 external to the jacket 10, both jointly sliding along the axis X by means of the rod 20. Therefore, the opposite end 22 as well as the end cylinder 21, may slide between the rest and the working positions.

It is understood that, in the case of a curved or suitably shaped rod, the end 22 may slide along an axis substantially parallel to the axis X without thereby departing from the scope of protection of the appended claims.

The end 22 may slide externally to the jacket 10 between a proximal position thereto, which may correspond to a rest position shown for example in FIGS. 4A and 6A, and a position distal therefrom, which may correspond to the working position shown for example in FIGS. 4B and 6B.

Accordingly, the end cylinder 21 may tightly slide within the jacket 10 between a position proximal to the end 13′ of the jacket 10, which may correspond to the rest position shown for example in FIGS. 4A and 6A, and a position distal therefrom, which may correspond to the working position shown for example in FIGS. 4B and 6B.

The jacket 10 may include a tubular element 11 defining the lateral wall thereof, a plug end 12 tightly screwed at the end 13′ of the tubular element 11 and a closing element 14 tightly screwed at the other end 13″ of the tubular element 11.

The rod 20 may be sliding assembled through a passing through opening 15 through the wall 14′ of the closing element 14.

Suitably, the end cylinder 21 may divide the jacket 10 in a first and a second variable volume compartments 18′, 18″. When the end 22 is in proximal position, as shown for example in FIGS. 4A and 6A, the variable volume compartment 18′ has the minimum volume while the variable volume compartment 18″ has the maximum volume, the opposite occur when the end 22 is in the working position, as shown for example in FIGS. 4B and 6B.

Advantageously, the linear actuator 1 may comprise movement promoting means, such as an elastic element 40 and, more particularly, a coil spring, operatively connected both with the jacket 10 and the rod 20 as to call back the end 22 from the distal position to the proximal position upon the movement thereof from the proximal to the distal position.

It is understood that, even though hereinafter an elastic element 40, and more particularly a coil spring, is described, the linear actuator 1 may comprise any movement promoting mean, for example hydraulic, magnetic or pneumatic, without thereby departing from the scope of protection of the appended claims.

In a preferred but not exclusive embodiment, the rod 20 may be internally hollow, with a tubular wall 23 defining a hollow chamber 24 which may contain the coil spring 40.

Moreover, means for the operative connection of the coil spring 40 respectively with the same jacket 10 and with the rod 20 may be provided, for example respective threaded elements 16 and 25.

The threaded element 25 may be screwed into the rod 20 in correspondence of the end 22, while the threaded element 16 may be screwed into the jacket 10 in correspondence of the end 13′.

It is understood that in the embodiment of the linear actuator 1 shown in FIGS. 4A and 4B the threaded element 16 may be screwed into a hollow plug 17 screwed itself in the jacket 10 so as to produce a valve body, as better explained below.

On the other hand, in the embodiment of the linear actuator 1 shown in FIGS. 6A and 6B the threaded element 16 may be directly screwed into the jacket 10, through one of its radially expanded portion 16′. It is clear that, even in such case, the threaded element 16 may be produced in several parts, such as for example in the embodiment shown in FIGS. 4A and 4B.

In this manner, the sliding of the end 22 from the proximal to the distal position may correspond to the loading of the spring 40, which may bring the same end 22 back to the rest position.

By suitably choosing the relative bulkiness of the threaded elements 16, 25 and of the spring 40, it may be possible to reciprocally fix them in a simple and effective manner, extremely promoting the assembly of the linear actuator 1.

In such case, indeed, it may be possible to screw the ends 41′ and 41″ of the spring 40 onto the elements 16 and 25, ensuring moreover a long-lasting fixing.

In a preferred but not exclusive embodiment, and independently from the presence of the coil spring 40, the jacket 10 may comprise damping means acting on the rod 20 so as to damp the movement of the end 22 upon the movement of the same end from the distal to the proximal position.

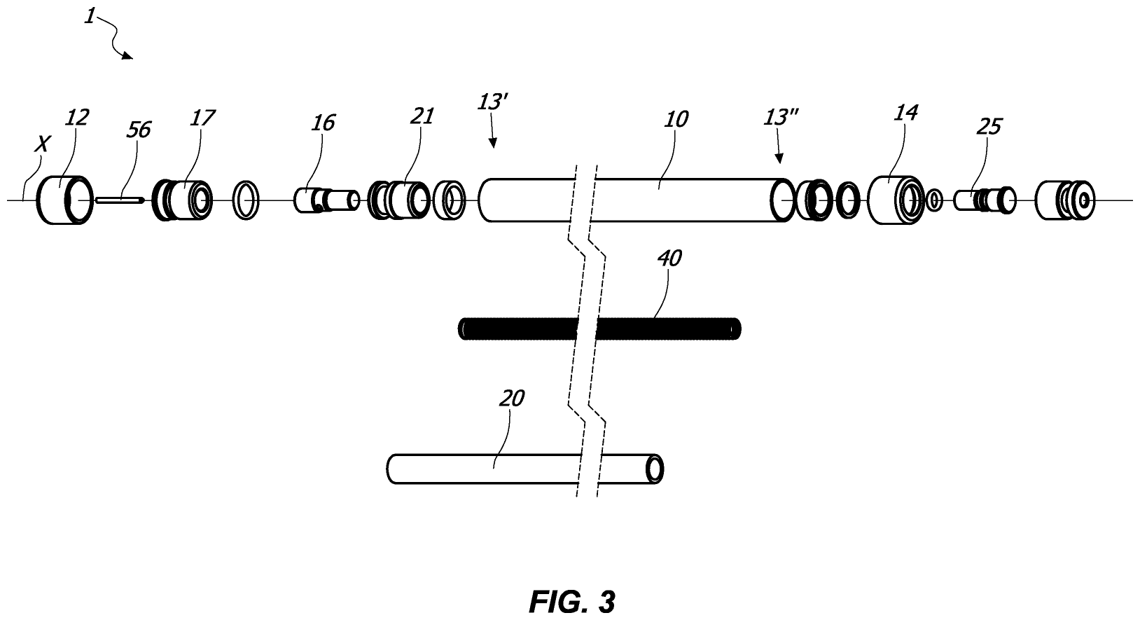

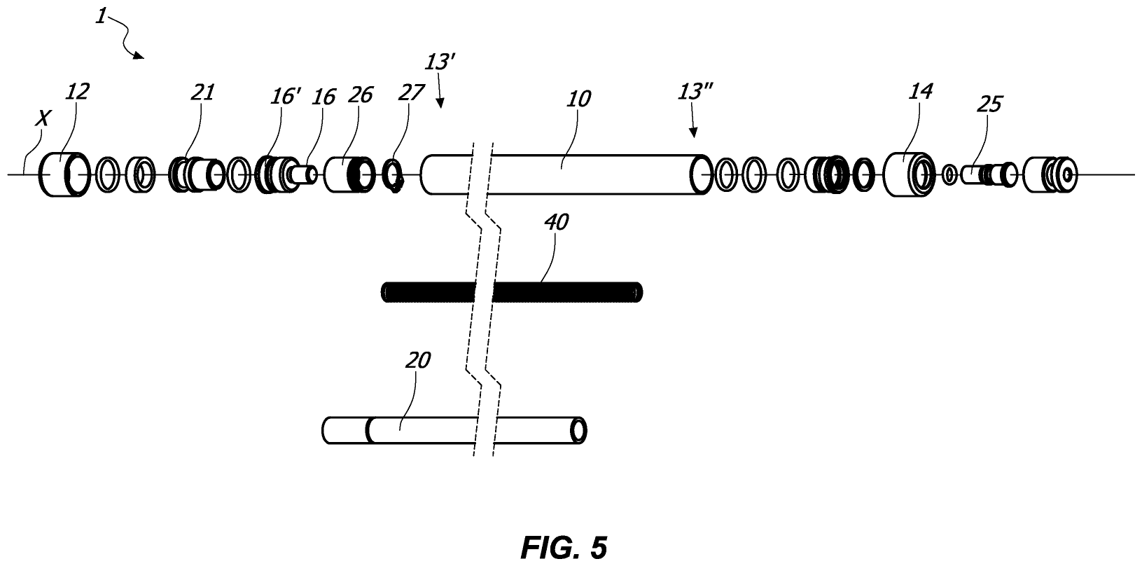

In the embodiment shown in FIGS. 3 to 4B, the damping means may be of a pneumatic type, while in the embodiment shown in FIGS. 5 to 6B, the damping means may be of a hydraulic type.

Anyway, the damping means may comprise a working fluid laying in at least one of the variable volume compartments 18′, 18″. Therefore, independently from its nature, the working fluid may act on the rod 20, by damping its movement.

In particular, in the embodiment illustrated in FIGS. 3 to 4B, the pneumatic working fluid, which may particularly be ambient air, is sucked in the compartment 18′ upon the movement of the end 22 from the proximal to the distal position.

Therefore, the compartment 18′ may expand filling up with air, while the other compartment 18″ may contract expelling the air present in the external environment through the opening 15. In order to obtain the damping effect, the two compartments 18′, 18″ may be reciprocally isolated, i.e. fluidically non-communicating with each other. On the other hand, each compartment 18′, 18″ may be fluidically communicating with the external environment.

Upon the movement of the end 22 from the distal to the proximal position, therefore, the air may be expelled from the compartment 18′ in a controlled manner, so as to obtain the damping effect.

In the embodiment shown in FIGS. 5 to 6B, the hydraulic working fluid, which may particularly be oil, fills up the entire jacket 10 and upon the movement of the end 22 from the proximal to the distal position, it passes from the compartment 18″ to the compartment 18′.

The compartment 18′ may therefore expand filling up with oil, while the other compartment 18″ may contract to flow out the oil that was originally contained in the compartment 18′. In order to obtain the damping effect, the two compartments 18′, 18″ may be fluidically communicating with each other.

Upon the movement of the end 22 from the distal to the proximal position, therefore, the oil may be expelled from the compartment 18′ in a controlled manner to pass in the compartment 18″, so as to obtain the damping effect.

To obtain the controlled flow out of the working fluid, moreover, appropriate controlling means may be provided, which may comprise a cylindrical valve element 26, in the case of the embodiment with hydraulic working fluid shown in FIGS. 5 to 6B or valve means 50 in the case of the embodiment with pneumatic working fluid shown in FIGS. 3 to 4B.

In particular, with reference to the embodiment with air illustrated in FIGS. 3 to 4B, the valve means 50 may comprise a valve body made of the threaded element 16 and the hollow plug 17, which may present a first opening 51 fluidically communicating with the external environment through the openings 52′, 52″ made in the end plug 12 and a second opening 54 fluidically communicating with the compartment 18′ through the two openings 55′, 55″.

Such embodiment of the valve body is particularly advantageous, since the threaded element 16 is both an integral part of the same valve body and a fixing device of the coil spring 40.

In the openings 51, 54 a passing-through pin 56 may be slidably inserted, so as to define a calibrated hole of proper bulkiness to obtain the damping effect between the opening and the same pin 56. In this manner, by appropriately choosing the relative dimensions between the pin 56 and the openings 51, 54 it may be possible to vary the damping effect.

The pin 56 may freely slide through the openings 51, 54, so as to keep it clean from extraneous matters or dust.

Moreover, a movable valve plug 57 may be provided in the valve body between a first operative position, shown for example in FIGS. 4B e 6B, away from the opening 51 wherein the flow passage for the oil entering the compartment 18′ may present a larger extension than the flow passage for the oil outgoing the same compartment 18′ which can be defined when the valve plug 57 is in a second operative position and into contact with the first opening 51, shown for example in FIGS. 4A and 6A.

On the other hand, with reference to the embodiment with oil shown in FIGS. 5 to 6B, the cylindrical valve element 26 may be inserted on the rod 20, free to tightly slide along the axis X.

In particular, the cylindrical valve element 26 upon its movement along axis X may come into contact with a stop ring 27 fitted on the tubular wall 23 and with the end cylinder 21.

More particularly, upon the movement of the end 22 from the distal to the proximal position, the cylindrical valve element 26 may come into contact with the stop ring 27 in order to be pushed towards the end 13′, as shown for example in FIG. 6A.

On the other hand, upon the reverse movement, the cylindrical valve element 26 may come into contact with the end cylinder 21 in order to be pushed towards the end 13″, as shown for example in FIG. 6B.

During such movement, the cylindrical valve element 26 may determine the resistance to the movement of the end 22 in both directions, i.e. for example the resistant force that the user perceives when opening the shutter D or the resistant force that opposes to the closing of the same shutter.

For this purpose, along the tubular wall 23 a first port 28′ and a second port 28″ may be provided, the latter being much bigger than the first one, respectively interposed between the stop ring 27 and the end 22, and between the same stop ring 27 and the distal end 13′.

Both ports 28′ and 28″ may put into fluidic communication the compartment 18″ and the compartment 18′ through a hollow chamber 24 of the rod 20.

During the movement of the cylindrical valve element 26 the stop ring 27 may prevent the same cylindrical valve element 26 from reaching the port 28′, keeping it always unobstructed.

On the other hand, upon the movement of the end 22 from the distal to the proximal position, the stop ring 27 may push the cylindrical valve element 26 to selectively cover the port 28″, as shown for example in FIG. 6A.

Therefore, during such movement, the oil may exclusively pass through the port 28′, which, having low-bulkiness, may provide a small flow passage for oil and a high correspondent resistant force.

On the other hand, during the reverse passage, the oil may pass through both ports 28′, 28″, therefore providing a much bigger flow passage for oil and, as a consequence, a minimum correspondent resistant force.

By suitably dimensioning the ports 28′, 28″ and suitably spacing the same ports with the cylindrical valve element 26, it may be possible to vary the damping effect of the actuator 1.

Also in such case, in order to minimize the bulkiness, the spring 40 may be fitted in the hollow chamber 24 of the rod 20.

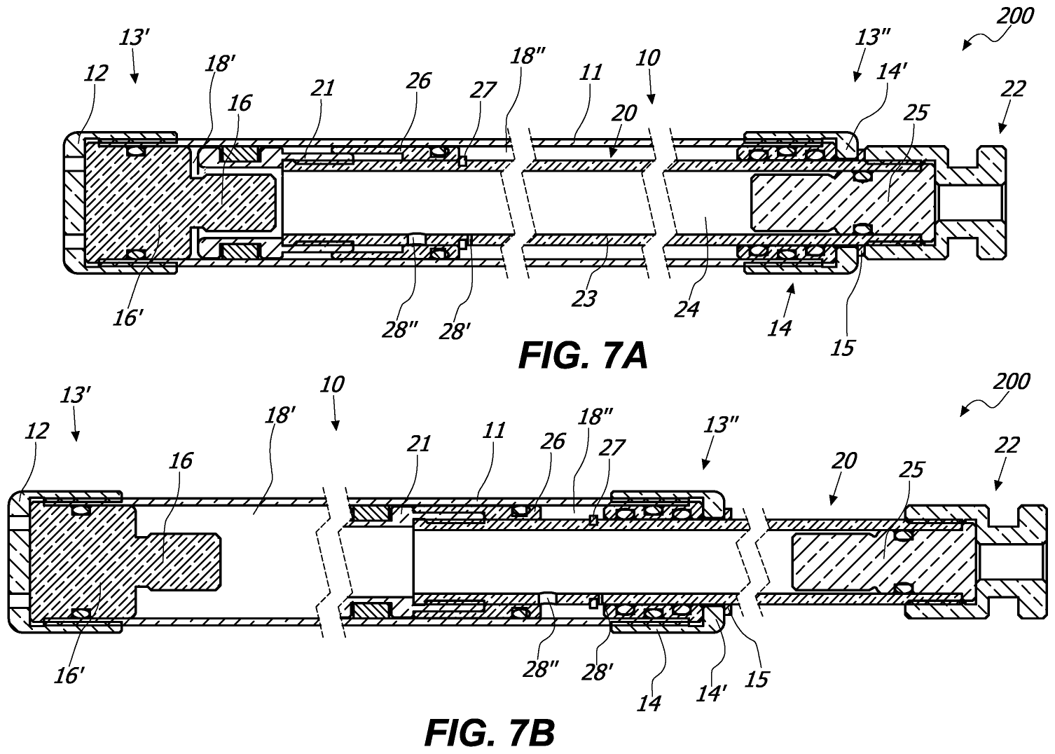

FIGS. 7A and 7B show a hydraulic damping cylinder 200, which may be configured like the embodiment of the linear actuator 1 shown in FIGS. 5 to 6B except for the presence of the spring 40 or, anyway, except for any other mean promoting the movement of the rod 20.

Such hydraulic damping cylinder 200 may be used in any application requiring the use of a damping force opposing the movement promoting force of the rod 20.

For example, the hydraulic damping cylinder 200 may be used in the system 100 in order to damp the movement of the shutter D when manually closed by a user, for example in order to prevent it from bumping against the frame W, or in an opening system of a closing element by gravity, for example in order to damp the opening movement of a hopper type window or French window.

From what described above, it is evident that the invention reaches the intended purposes.

The invention is susceptible to numerous modifications and variations, all falling within the inventive concept of the appended claims. All the details may be replaced with other technically equivalent elements and the materials may be different according to requirements, without thereby departing from the scope of protection of the invention.

Even though the present invention has been described with specific reference to the appended figures, the reference numbers used in the description and in the claims are used in order to improve the invention, and they do not constitute any limitation to the claimed scope of protection.

The invention claimed is:

1.-41. (canceled)

42. A linear actuator comprising:
a jacket defining a longitudinal axis; and
a rod having a cylinder at one end inserted in the jacket and an opposite end external to the jacket and reciprocally slidable along the longitudinal axis or an axis parallel thereto in relation to the jacket between a position proximal to the jacket and a position distal therefrom, the cylinder dividing the jacket in at least one first and at least one second variable volume compartments fluidically non-communicating with each other and each fluidically communicating with an external environment;
wherein the jacket comprises an elastic element operatively connected to the jacket and to the rod so as to move the opposite end from one of the distal or proximal positions to another one of the distal or proximal positions upon a movement of the opposite end from the other one of the distal or proximal positions to the one of the distal or proximal positions,
wherein the jacket further comprises damping means acting on the rod (to damp the movement of the opposite end upon the movement thereof from the one of the distal or proximal positions to the other one of the distal or proximal positions, the damping means comprising a working pneumatic fluid laying in at least one of the first or second variable volume compartments, the pneumatic working fluid being ambient air sucked from the external environment or blown off toward the external environment,
wherein, upon the movement of the opposite end from the one of the distal or proximal positions to the other one of the distal or proximal positions, one of the at least one first or at least one second variable volume compartments expands to at least partially fill up with the ambient air and the other one of the at least one first and at least one second variable volume compartments contracts,
wherein, upon the movement of the opposite end from the other one of the distal or proximal positions to the one of the distal or proximal positions, the other one of the at least one first or at least one second variable volume compartments expands and the one of the at least one first or at least one second variable volume compartments contracts so that the ambient air at least partially flows out, the damping means further comprising control means for an outflow out of the ambient air, and
wherein the one of the one first or at least one second variable volume compartments is fluidically communicating with the external environment through the control means, the control means including a valve configured to allow a suction of the pneumatic working fluid from the external environment upon the movement of the opposite end from the one of the distal or proximal position to the other one of the distal or proximal position and to allow a controlled blow-off upon a reverse passage.

43. The linear actuator according to claim 42, wherein the elastic element is operatively connected with the jacket and with the rod to move the opposite end from the distal position to the proximal position upon the movement of the opposite end from the proximal position to the distal position.

44. The linear actuator according to claim 42, wherein the rod is internally hollow, the elastic element being disposed within the rod.

45. The linear actuator according to claim 44, wherein the jacket comprises a first end proximal to the opposite end of the rod and a second end distal therefrom, the jacket comprising first means for a reciprocal operative connection with the elastic element by the distal end, the rod comprising second means for the reciprocal operative connection with the elastic element placed by the opposite end.

46. The linear actuator according to the claim 45, wherein the elastic element comprises a coil spring, the first means comprising a first threaded element fixed by the distal end and reciprocally connected with one end of the coil spring, the second means comprising a second threaded element fixed by the opposite end and reciprocally connected with another end of the coil spring.

47. The linear actuator according to claim 45, wherein the valve comprises a valve body having a first opening in fluidic communication with the external environment and a second opening in fluidic communication with the one of the at least one first or at least one second variable volume compartments, the valve further comprising a valve plug selectively acting on the first opening to enable a sucking/blowing off of the pneumatic working fluid from/to the external environment, the valve body comprising the first means.

48. A system for opening/closing a sliding closing element comprising:
at least one sliding closing element; and
at least one linear actuator operatively connected thereto,
wherein the at least one linear actuator is a linear actuator according to claim 42.
